(19) United States
(12) Patent Application Publication
(10) Pub. No.: US 2003/0231849 A1
(43) Pub. Date: Dec. 18, 2003

(54) Closures and cassettes for housing bridge and/or transition optical fibers in dispersion-managed networks

(76) Inventors: Diana Rodriguez, Alvarado, TX (US); Steve A. Fontaine, Ft. Worth, TX (US); Laurent Potard, NorthRichland Hills, TX (US); Jennifer A. Battey, Euless, TX (US); Andrew D. Hoflich, Plano, TX (US); Aaron I. Blankenship, Keller, TX (US); James M. Carlson, Ft. Worth, TX (US); Kevin L. Strause, Keller, TX (US)

Correspondence Address: CORNING CABLE SYSTEMS LLC, P O BOX 489, HICKORY, NC, 28603, US

(21) Appl. No.: 10/173,938

(22) Filed: Jun. 18, 2002

(51) Int. Cl. G02B 6/00

(52) U.S. Cl. 385/135

(57) ABSTRACT

A fiber optic cable closure for containing optical fibers of a dispersion-managed network. The fiber optic closure has a housing with a cavity, and at least one bridge optical fiber disposed within the cavity. The bridge optical fiber having a first end configured to optically connect to a first optical fiber with a first dispersion characteristic. A second end of the bridge optical fiber is configured to optically connect with a second optical fiber having a second dispersion characteristic. In one embodiment, the fiber optic cable closure includes a fiber optic cassette within the cavity of the housing when assembled.

### FIELD OF THE INVENTION

The present invention relates generally to fiber optic cable closures for optical fibers, splices, and/or connections. More specifically, the invention relates to fiber optic cable closures and fiber optic cassettes for housing bridge and/or transition optical fibers for use in a dispersion-managed network (DMN).

### BACKGROUND OF THE INVENTION

Fiber optic cables include optical waveguides such as optical fibers that transmit optical signals may include voice, video, and/or data information. Optical fibers of different fiber optic cables can be optically connected together, thereby forming an optical pathway. These optical pathways can form a portion of a fiber optic network that can span long distances. Fiber optic networks typically include closures at splice locations such as distribution hubs in the fiber optic network. In the field, craftsmen route fiber optic cables into a closure at a hub location and can splice the optical fibers of the cables together, thereby forming a portion of a fiber optic network. The amount of data information that a fiber optic network can accommodate is called bandwidth. Bandwidth is usually measured in Gigabits per second (Gbps).

One way to increase bandwidth is by wavelength-division multiplexing (WDM). WDM is sending multiple optical signals, where each signal has a slightly different wavelength, through a single optical fiber. Another way to increase the bandwidth of a fiber optic network is to transmit the data at a faster rate. However, there are limits on the bandwidth that a fiber optic network can accommodate due to the optical degradation of the optical signal as it travels along the optical fiber. Optical signals degrade due to optical performance characteristics of the optical fibers such as optical attenuation, optical connection loss, and/or chromatic dispersion.

Generally speaking, optical attenuation is a loss in transmitted power. Optical attenuation is typically due to absorption, scattering, and leakage of light from the optical waveguide and is customarily measured in a fiber, or cable, as a loss in transmitted power per unit length such as dB/km. A loss in transmitted power is undesirable because a weak optical signal is difficult to detect. Additionally, optical connections between optical fibers such as splices can have a loss in transmitted power, but optical connection losses are generally measured in decibels (dB).

On the other hand, chromatic dispersion is the differential transit time of adjacent wavelengths in an optical fiber of a WDM system. Chromatic dispersion results in pulse spreading of the optical signals, which makes the optical signals difficult to detect. Chromatic dispersion in fiber optic waveguides is the sum of material and waveguide dispersions and is generally measured in picoseconds of pulse spreading per nanometer of source per kilometer of optical fiber length (ps/(nm·Km)).

Material dispersion results from the differences in refractive index with respect to wavelengths being transmitted in the optical waveguide. For silica-based glass used for optical fibers, material dispersion increases with the wavelength being transmitted in the commonly used communication range of about 0.9 μm to 1.6 μm. Material dispersion can have a negative or a positive sign depending on the wavelength.

Conversely, waveguide dispersion results from light traveling in both the core and cladding of an optical fiber. Waveguide dispersion is a function of wavelength and the refractive index profile of the optical fiber. For example, a predetermined refractive index profile of the optical fiber can be selected to influence the wavelength dependency of wavelength dispersion therein, thereby influencing the chromatic dispersion at a predetermined wavelength.

Wavelength and material dispersion effects can be influenced to yield an overall positive or negative chromatic dispersion characteristic in a given optical fiber at a given wavelength. As a result of these optical characteristics, optical fibers and/or networks are generally designed to minimize the chromatic dispersion characteristic at a specific wavelength such as 1.3 μm to inhibit degradation of the optical signal at that wavelength. However, using wavelengths other than the intended wavelength, or spanning distances greater than intended, can result in appreciable chromatic dispersion that effects optical performance.

One way to overcome chromatic dispersion characteristics is by using additional network equipment such as repeaters and/or regenerators to preserve the optical signal. However, the additional equipment adds undesirable expense and labor to the fiber optic network.

Other methods that compensate for chromatic dispersion can avoid the additional costs of repeaters and/or regenerators; however, these methods have other difficulties. For instance, U.S. Pat. No. 5,933,561 ('561) discloses splicing a length of an optical fiber section to an existing single mode optical fiber pathway. The existing single mode optical fiber pathway is designed to have relatively low chromatic dispersion at a wavelength of 1.3 μm, but has appreciable chromatic dispersion at a wavelength of 1.55 μm. By splicing a length of an optical fiber section to the existing single mode optical fiber pathway, the chromatic dispersion at 1.55 μm of the existing optical fiber pathway can be offset, thereby allowing the use of a 1.55 μm wavelength while maintaining acceptable performance.

In particular, the '561 patent discloses a dispersion compensating optical fiber connector body having three different optical fibers with specific optical characteristics. Sizing the three optical fibers as disclosed the '561 patent can reduce the total connection loss of the connector body compared with directly splicing the positive dispersion and dispersion compensating optical fibers together. However, the connector body is still subject to the optical performance constraints associated with splice losses. The splicing operation between the three optical fibers of the connector body requires special, expensive, and sensitive splice equipment to precisely align the different types of optical fibers. This type of splicing equipment is not desirable for use in the field by the craftsman. In particular, the connector body requires an active alignment splicing device capable of moving an aligning base in at least two dimensions to precisely align the optical fibers, thereby minimizing the splice loss in the connector body.

On the other hand, the craftsman in the field desires to minimize the equipment he carries in size, quantity, and complexity. For example, a craftsman prefers to carry small, lightweight, and ruggedized equipment. Moreover, it is expensive to train and equip each craftsman with special equipment that will be subject to field use and abuse.

### SUMMARY OF THE INVENTION

The present invention is directed to a fiber optic cable closure for containing optical fibers of a dispersion-managed network. The fiber optic cable closure includes a housing having a cavity, and at least one bridge optical fiber disposed within the cavity. The bridge optical fiber has a first end and a second end. The first end being configured to optically connect to a first optical fiber having a first dispersion characteristic, and the second end being configured to optically connect to a second optical fiber having a second dispersion characteristic.

The present invention is also directed to a fiber optic cassette for containing optical fibers of a dispersion-managed network. The fiber optic cassette including a first storage area, and at least one bridge optical fiber having a first and second end. At least a portion of the bridge optical fiber is disposed within the first storage area. The first end is configured to optically connect with a first optical fiber having a first dispersion characteristic, and the second end is configured to optically connect with a second optical fiber having a second dispersion characteristic.

The present invention is further directed to a fiber optic cassette for containing optical fibers of a dispersion-managed network. The fiber optic cassette including a first storage area, a second storage area, at least one bridge optical fiber, a first optical fiber, and a second optical fiber. The bridge optical fiber has a first end and a second end, and at least a portion of the at least one bridge optical fiber is disposed in the first storage area. The first optical fiber is a transition optical fiber having a positive dispersion (D+) characteristic and is in optical communication with the first end of the at least one bridge optical fiber. The second optical fiber being a transition optical fiber having a negative dispersion (D−) characteristic and is in optical communication with the second end of the at least one bridge optical fiber. At least a portion of the first and second optical fibers is disposed in the second storage area.

Additionally, the present invention is directed to a dispersion-managed network including a first fiber optic cable, a second fiber optic cable, a fiber optic cable closure, and at least one bridge optical fiber. The first fiber optic cable has at least one positive dispersion (D+) optical fiber. The second fiber optic cable has at least one negative dispersion (D−) optical fiber. The fiber optic cable closure having a housing with a cavity, and at least a portion of the first and second fiber optic cables is disposed within the cavity. The at least one bridge optical fiber having a first and second end disposed within the cavity of the housing with the at least one D+ and D− optical fibers being in optical communication with the at least one bridge optical fiber.

### BRIEF DESCRIPTION OF THE FIGS.

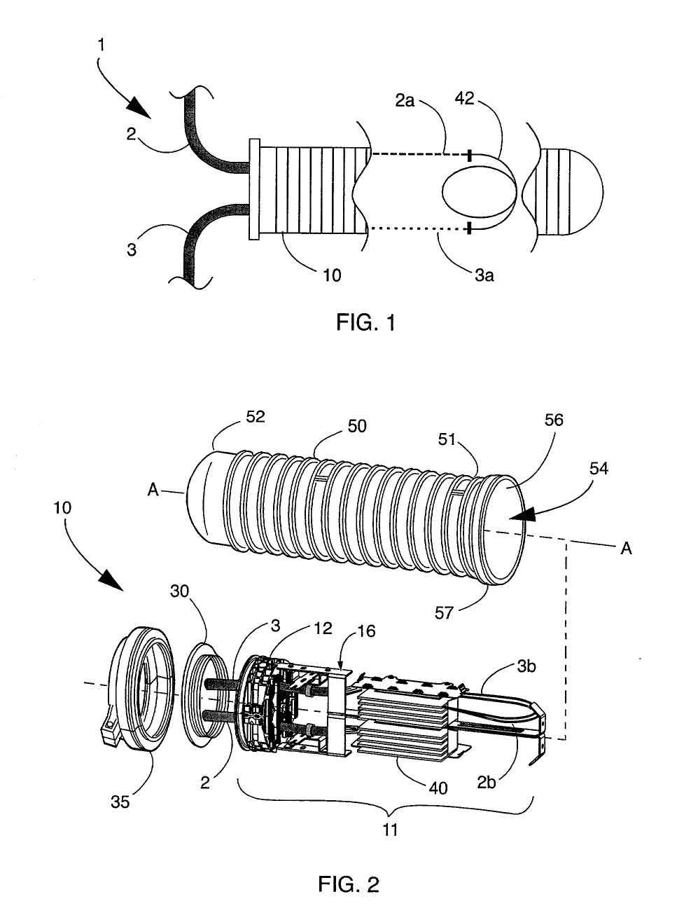

FIG. 1 is a partial schematic view of a portion of a dispersion-managed network (DMN) according to one embodiment of the present invention.

FIG. 2 is a partially exploded, partially perspective view of a butt-type fiber optic cable closure for containing optical fibers, splices, and/or connections according to one embodiment of the present invention.

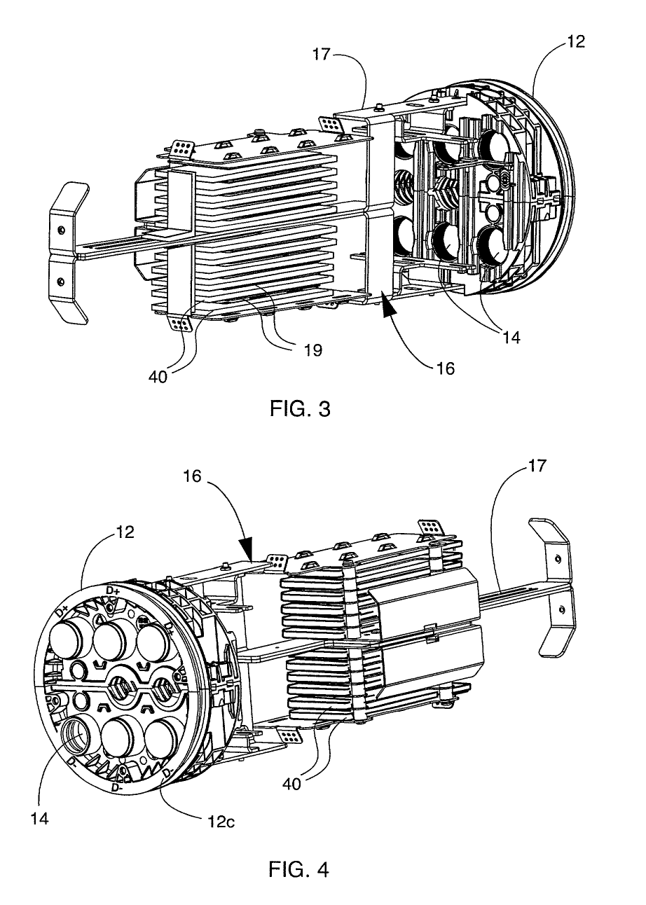

FIG. 3 is a rear perspective view of portions of the fiber optic cable closure of FIG. 2.

FIG. 4 is a front perspective view of portions of the fiber optic cable closure of FIG. 2.

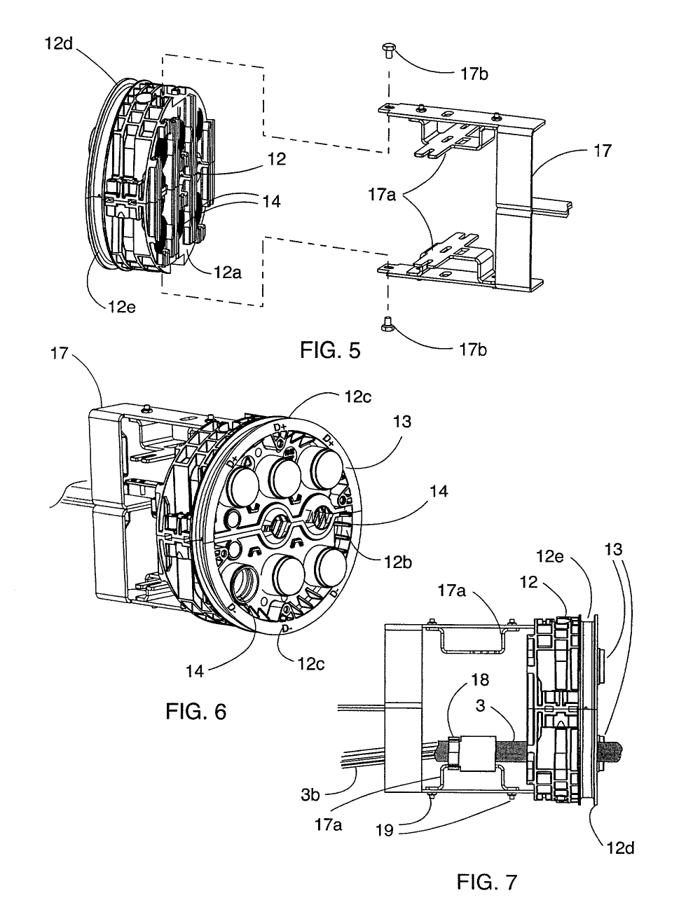

FIG. 5 is a partially exploded, partially perspective view of the end cap and portion of the support frame of the fiber optic cable closure of FIG. 2.

FIG. 6 is a front perspective view of the end cap and portion of the support frame of the fiber optic cable closure of FIG. 2

FIG. 7 is a side view of the end cap, a portion of the support frame, and other components that can be used with the fiber optic cable closure of FIG. 2.

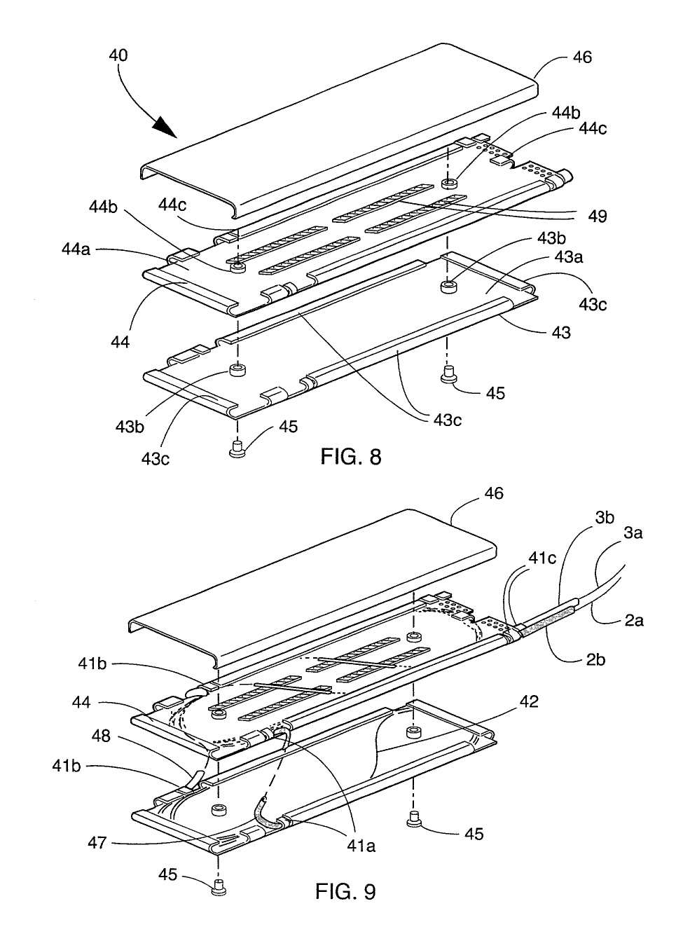

FIG. 8 is a partially exploded perspective view of a portion of fiber optic cassette assembly that can be used in the fiber optic cable closure of FIG. 2.

FIG. 9 is a partially exploded perspective view of the fiber optic cassette assembly of the fiber optic cable closure of FIG. 2 having optical fibers therein.

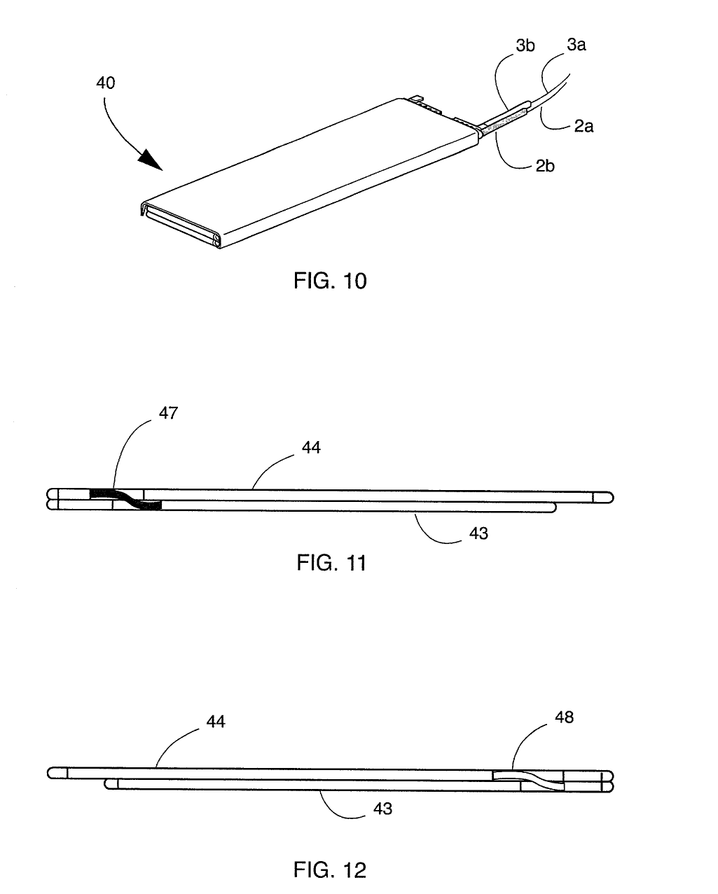

FIG. 10 is a perspective view of the assembled fiber optic cassette assembly of FIG. 9.

FIG. 11 is a side view of a portion of fiber optic cassette assembly of FIG. 10 with the plate removed.

FIG. 12 is another side view of a portion of fiber optic cassette assembly of FIG. 10 with the plate removed.

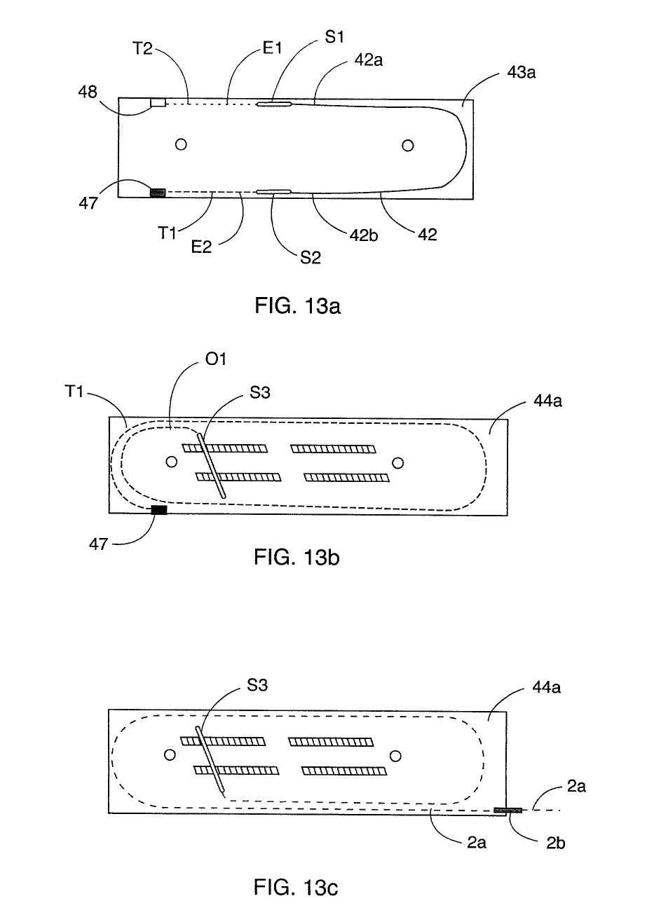

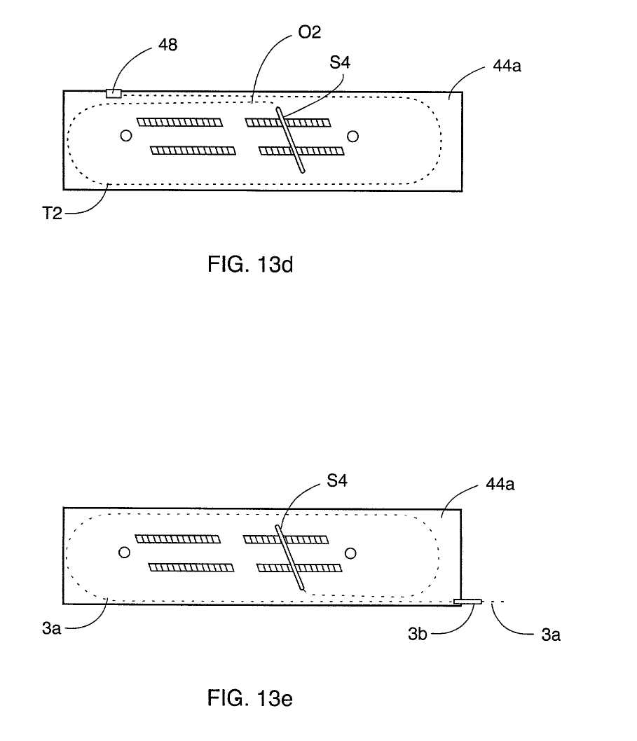

FIG. 13a is a schematic plan view of a routing of scheme for the bridge optical fiber disposed in the first storage area of the fiber optic cassette assembly of FIG. 9.

FIG. 13b is a schematic plan view of a routing scheme for the first transition optical fiber disposed in the second storage area of the fiber optic cassette assembly of FIG. 9.

FIG. 13c is a schematic plan view of a routing scheme for the first optical fiber disposed in the second storage area of the fiber optic cassette assembly of FIG. 9.

FIG. 13d is a schematic plan view of a routing scheme for the second transition optical fiber disposed in the second storage area of the fiber optic cassette assembly of FIG. 9.

FIG. 13e is a schematic plan view of a routing scheme for the second optical fiber disposed in the second storage area of the fiber optic cassette assembly of FIG. 9.

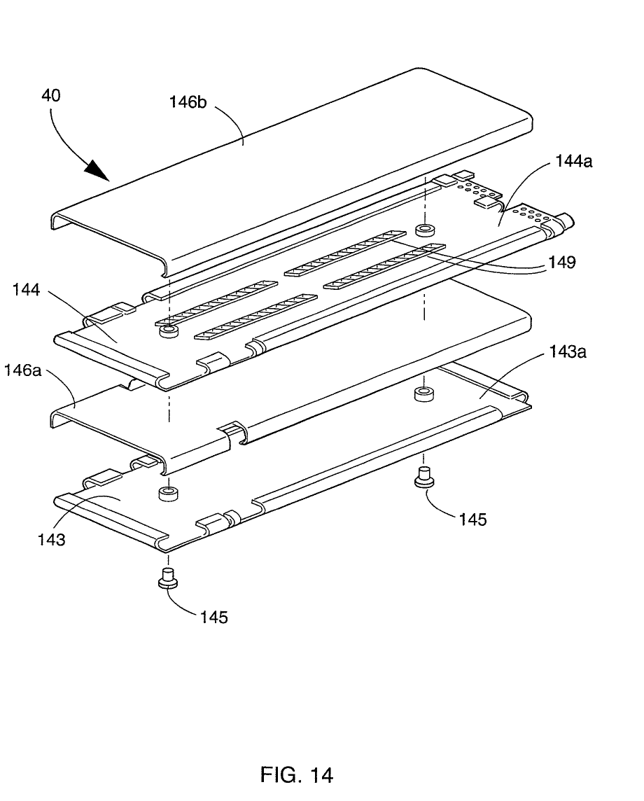

FIG. 14 is an exploded perspective view of another fiber optic cassette assembly according to the present invention.

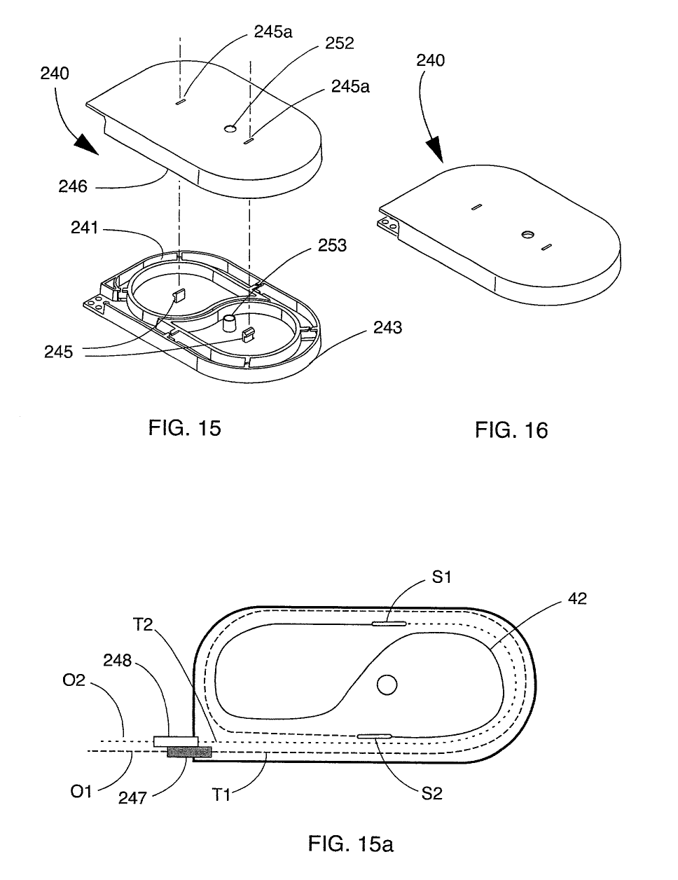

FIG. 15 is an exploded perspective view of another fiber optic cassette assembly according to the present invention.

FIG. 15a is a schematic plan view of a routing scheme for optical fibers disposed in a storage area of the fiber optic cassette assembly of FIG. 15.

FIG. 16 is a perspective view of the assembled fiber optic cassette assembly of FIG. 15.

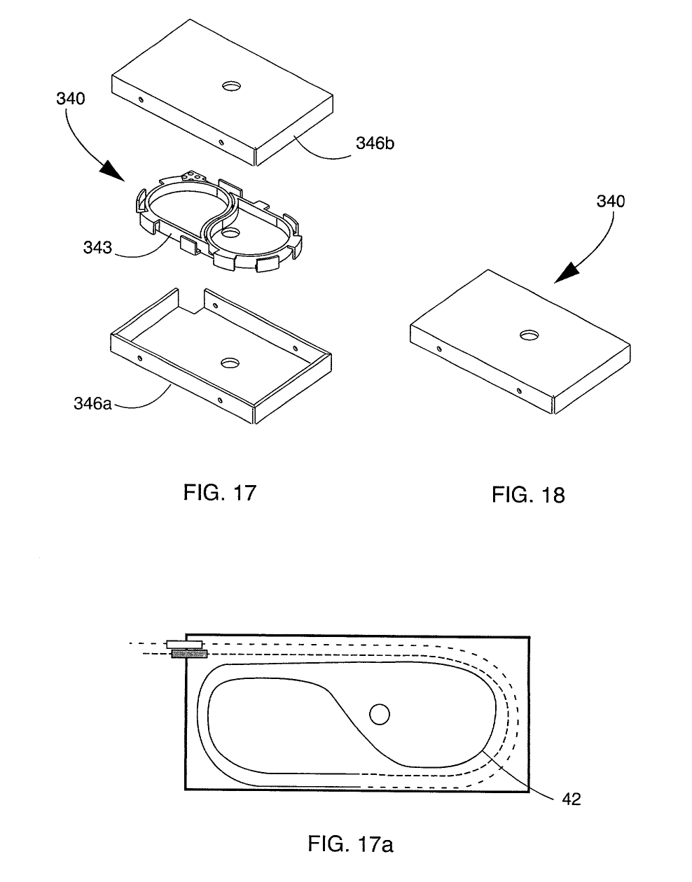

FIG. 17 is an exploded perspective view of another fiber optic cassette assembly according to the present invention.

FIG. 17a is a schematic plan view of a routing scheme for a 30 bridge optical fiber disposed in a storage area of the fiber optic cassette assembly of FIG. 17.

FIG. 18 is a perspective view of the assembled fiber optic cassette assembly of FIG. 17.

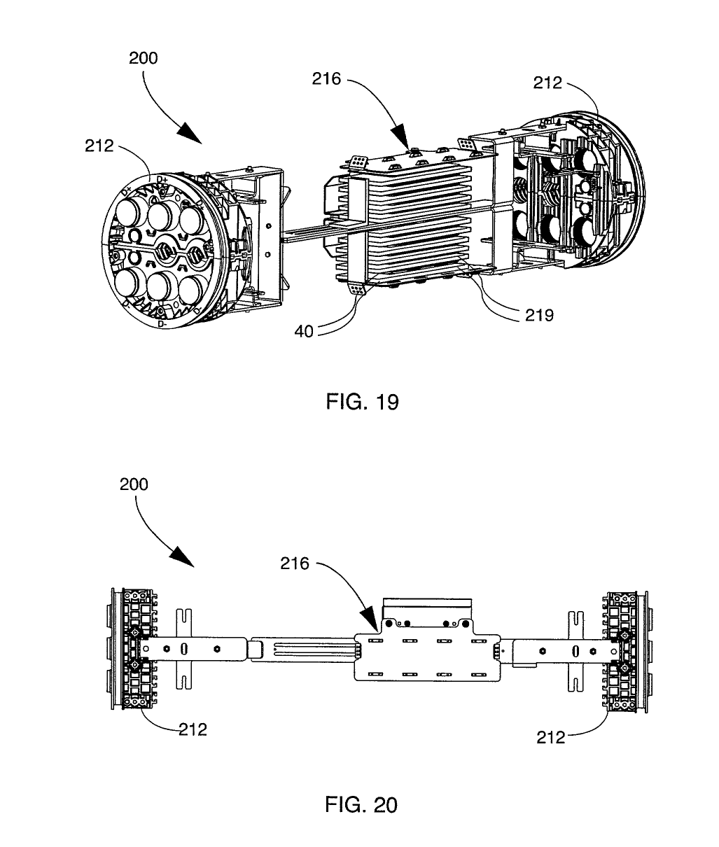

FIG. 19 is a perspective view of a subassembly of an in-line fiber optic cable closure according to another embodiment of the present invention.

FIG. 20 is a top plan view of the subassembly of FIG. 19.

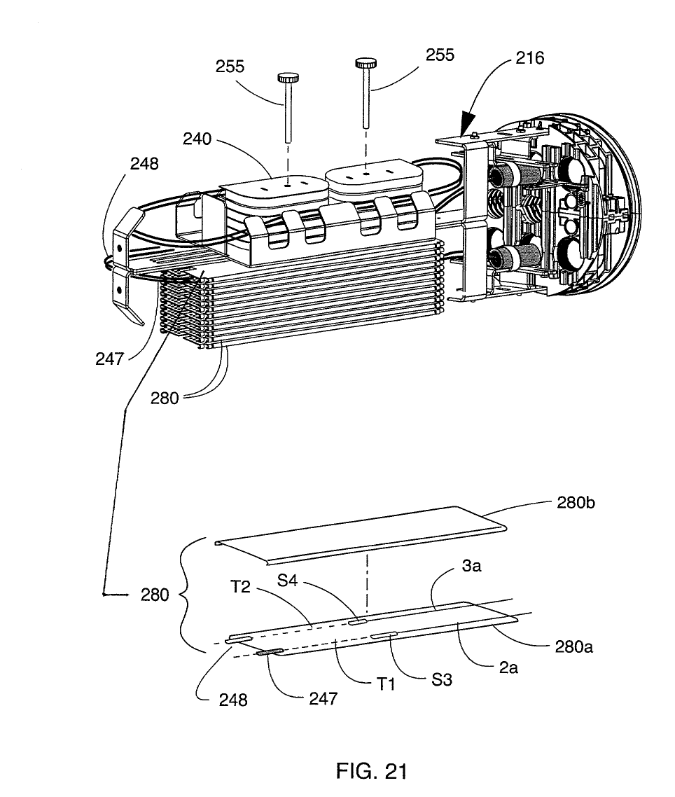

FIG. 21 is a partially exploded, partially perspective view of a butt-type fiber optic cable closure using the cassette of FIG. 15 according to another embodiment of the present invention.

### DETAILED DESCRIPTION OF THE INVENTION

Illustrated in FIG. 1 is a portion of a dispersion-mananged network (DMN) 1 according to the present invention. DMN 1 includes a first fiber optic cable 2 having at least one optical fiber 2a with a first dispersion characteristic, a second fiber optic cable 3 having at least one optical fiber 3a with a second dispersion characteristic, at least one bridge fiber 42, and a fiber optic cable closure 10. However, the DMN can include additional fiber optic cables, fiber optic cable closures, transition optical fibers and/or other suitable components. The DMN offsets the dispersion characteristics of the optical fibers of an optical pathway so that the DMN has a relatively low net dispersion, preferably an essentially zero net dispersion. Thus, DMNs according to the present invention allow for increased bandwidth and/or longer transmission distances with improved optical performance.

As used herein, the first and second dispersion characteristics of optical fibers 2a,3a mean different dispersion characteristics measured at the same reference wavelength.

Different dispersion characteristics mean dispersion characteristics associated with, for example, different types of optical fibers having different optical characteristics such as mode-field diameters (MFD), core diameters, cladding diameters, refractive index profiles, and/or refractive indices, rather than dispersion characteristics associated with the same, or similar, types of optical fibers due to manufacturing variances.

For example, at a reference wavelength of 1550 nm, optical fiber 2a may have a positive dispersion (D+) characteristic and optical fiber 3a may have a negative dispersion (D−) characteristic. While traveling through a D+ optical fiber, an optical pulse signal stretches, thereby increasing its duration compared with the original optical signal. On the other hand, while traveling through a D− optical fiber, the optical pulse is shortened, thereby decreasing its duration compared with the original optical signal. Thus, by optically connecting suitable lengths of D+ and D− optical fibers the net dispersion of a DMN can be manipulated to have a relatively low net dispersion.

However, a direct optical connection between optical fibers having extremely different first and second dispersion characteristics can undesirably result in a relatively high splice loss. For example, directly connecting D+ and D− optical fibers having MFDs of about 11.5 μm and 6.0 μm, respectively, results in a relatively high splice loss. To overcome this relatively high splice loss, the DMNs of the present invention optically connect D+ and D− optical fibers in a fiber optic cable closure with bridge fiber 42 therebetween. In one embodiment, the bridge fiber acts as gradual change in MFD between the D+ and D− optical fibers, thereby allowing for a relatively low splice loss. Even though bridge fiber 42 has different optical characteristics than either the D+ or D− optical fibers, the splice loss is advantageously reduced compared with a direct D+ to D− splice. Illustratively, the MFD of bridge fiber 42 is less than or about equal to the MFD of the D+ optical fiber and greater than or about equal to the MFD of the D− optical fiber. For instance, a bridge fiber with a MFD of about 8.6 μm can be used with the D+ and D− optical fibers described above, thereby making a gradual change in MFD. However, other bridge fibers having other suitable MFDs and/or other suitable optical characteristics can be used. Additionally, one or more of the optical characteristics of bridge fiber 42 may be the same, or similar, to either, or both of optical fibers 2a,3a.

FIG. 2 depicts an explanatory butt-type fiber optic cable closure 10 according to one embodiment of the present invention. Fiber optic cable closure 10 is suitable for containing optical fibers, optical fiber splices, other suitable optical connections and/or components of a dispersion-managed network (DMN). Fiber optic cable closure 10 (hereinafter closure) preferably includes a subassembly 11 having an end cap 12 with a frame assembly 16 attached thereto, at least one fiber optic cassette assembly 40, an O-ring 30, a collar 35, and a housing 50.

As shown in FIGS. 3-6, end cap 12 has a predetermined diameter and includes a first end 12a and a second end 12b. A plurality of ports 14 extending through the end cap from the first end 12a to the second end 12b of end cap 12 and are configured for receiving fiber optic cables. As shown in FIG. 6, ports 14 may be sealed at the second end 12b by a plurality of respective covers 13 that can be molded into end cap 12, thereby sealing the ports 14 when not occupied by a fiber optic cable. Thus, in this embodiment cover 13 must be removed before using the respective port 14. For example in FIG. 6, removing two covers 13 opens the two respective ports 14, thereby allowing the ports to receive first and second fiber optic cables 2,3. In other configurations, plugs may be used to seal ports 14.

End cap 12 can also include a marking indicia 12c to aid the craftsman in identifying, and positioning, fiber optic cables 2,3 in predetermined ports 14 of end cap 12. For example, adjacent the respective ports 14 of end cap 12 are the indicia “D+” and “D−” suggesting ports 14 for respective fiber optic cables. However, other suitable marking indicia 12c can be used and/or be located on other suitable locations of end cap 12, or on other suitable locations of closure 10. In other embodiments, fiber optic cables 2,3 can be marked with an indicia to identify the optical fibers therein.

Attached to the first end 12a of end cap 12 is frame assembly 16. Frame assembly 16 includes support frame 17, strain relief brackets 17a and cassette stackers 19 (See FIG. 3). Support frame 17 is attached to end cap 12 by a fastening elements 17b, such as a pair of threaded bolts, that extend through apertures in support frame 17 (FIG. 5) and attach adjacent to first end 12a of end cap 12. Other suitable fastening elements such as quarter-turn screws, or snap-fits can be used. Frame assembly 16 has a storage means or portion for routing and storing buffer tubes 2b,3b (FIG. 2) of fiber optic cables 2,3. For example, buffer tubes 2b,3b can protect the optical fibers of the fiber optic cables as they are routed to a predetermined fiber optic cassette 40 for optical connection therein.

Preferably, the sheath and the strength member of a fiber optic cable are clamped to a strain relief bracket 17a that is attached to support frame 17 by an attachment element 19. Attachment element 19 can be any suitable fastener such as bolts, rivets, welds, etc. Clamping of the sheath of the fiber optic cable to the strain relief bracket can be accomplished, for example, with a hose clamp 18, however, other suitable elements may be used. Clamping the sheath to strain relief bracket inhibits the fiber optic cable from being pulled out of the closure. Likewise, the central strength member of the fiber optic cable can be restrained (not shown) to inhibit the same from pistoning into closure 10 during temperature variations.

As shown in FIG. 2, housing 50 preferably has a generally cylindrical shape about a longitudinal axis A-A with a first end 51 and a second end 52. Adjacent to first end 51, housing 50 includes an opening 56 to a cavity 54, and a circumferential flange 57 adjacent to the opening 56, whereas, second end 52 of housing 50 is closed. When closure 10 is assembled, a majority of subassembly 11 fits within housing 50 with end cap 12 being adjacent to opening 56 to generally close the same, thereby protecting that portion of subassembly 11 within cavity 54 from environmental elements. Preferably, closure 10 includes a split annular collar 35 that securely engages circumferential flange 57 of housing 50 and a circumferential flange 12d (FIG. 5) of end cap 12 to secure the end cap 12 to housing 50. Collar 35 and circumferential flanges 57,12d cooperate with O-ring 30 that is received in a circumferential channel 12e defined by end cap 12. However, end cap 12 may be secured to housing 50 in other suitable manners as known to those skilled in the art. Additionally, the concepts of the present invention can be practiced with closures, housings, and/or other suitable environmentally sealed devices having other suitable shapes, sizes, and configurations. For example, other sealed devices may include above-grade, below-grade, or aerial closures; however, housings such as pedestals can also be used.

FIG. 8 illustrates a portion of an explanatory fiber optic cassette assembly 40 (hereinafter cassette) for use with fiber optic cable closure 10. Cassette 40 can be made from, for example, metal, dielectric, or any other suitable material and is capable of being removably attached to frame assembly 16. FIG. 9 illustrates cassette 40 with a portion of the optical pathway contained therein. In this embodiment, cassette 40 has a friction fit within cassette stackers 19 of frame assembly 16 (FIG. 3). However, other suitable elements can be used to secure cassette 40 to frame assembly 16. For example, cassette 40 can be removably secured with Velcro® straps, friction fits using such features as dimples or resilient members, bolts, or other suitable elements.

As depicted in FIGS. 8 and 9, cassette 40 includes a first tray 43 having a first storage area 43a and a second tray 44 having a second storage area 44a, at least one fastening element 45, a plate 46, and a pair of transition tubes 47,48. First tray 43 and second tray 44 can be removably secured together by fastening elements 45, for example, threaded fasteners such as a bolts, or quarter-turn screws. Thus, when secured together, removal of fastening elements 45 is required to access first storage area 43a. In one embodiment, fastening elements 45 can have a non-standard head that requires a special engagement tool to drive the same. In other embodiments, fastening elements 45 can be latches, snap-fitting portions, or clamps.

Specifically, fastening elements 45 such as bolts are received through a pair of apertures in first tray 43 that have a pair of standoffs 43b that maintain second tray 44 at a predetermined distance away from storage area 43a. Fastening elements 45 are received in a pair of threaded bores in second tray 44 to secure trays 43 and 44 together. On the other hand, plate 46 removably attaches to second tray 44 with a friction fit, thereby allowing relatively easy access to second storage area 44a the for reasons which will be discussed herein. The threaded bores of second tray 44 for engaging fastening elements 45 may be within a pair of standoffs 44b. Additionally, standoffs 44b inhibit plate 46 from entering storage area 44a. Preferably, trays 43,44 contain rails 43c,44c adjacent to the tray edges to retain optical fibers within storage areas 43a,44b; however, other suitable elements can be used. A plurality of splice organizers 49 are disposed within second storage area 44a. Splice organizers 49 define a plurality of parallel grooves for receiving and organizing optical splices therein.

FIG. 10 illustrates an assembled cassette having buffer tubes 2b,3b entering second storage area 44a. In other embodiments, buffer tubes 2b,3b can enter the second storage area 44a at other suitable locations, for example, the same side of tray 44, but at opposite ends. In the field, the craftsman would route buffer tubes 2b and 3b having optical fibers 2a,3a of fiber optic cables 2,3 to the second tray 44 for optical connection. The optical connection is with a pair of transition optical fibers T1,T2 as will be discussed. Buffer tubes 2b,3b can be removably secured to second tray 44 by crimping tab 41c therearound. Additionally, other suitable elements can be used to secure buffer tubes 2b,3b such as tie wraps secured to apertures of second tray 44.

Bridge fiber 42, first transition optical fiber T1, second transition optical fiber T2, and optical fibers 2a,3a are schematically represented in FIGS. 13a-13e to illustrate an exemplary routing and splicing of the same within cassette 40. For clarity of the optical fiber routing and splicing, first storage area 43a is depicted in FIG. 13a and second storage area 44a is depicted in FIGS. 13b-13e. More specifically, FIG. 13a illustrates a splice S1 between a first end 42a of bridge optical fiber 42 and a first end E1 of transition optical fiber T1. Likewise, FIG. 13a also illustrates a splice S2 between a second end 42b of bridge optical fiber 42 and a first end E2 of transition optical fiber T2. Respectively, FIGS. 13b, 13c, 13d and 13e illustrate the routing of one optical fiber to a splice as follows: first transition optical fiber T1 to a splice S3; optical fiber 2a of fiber optic cable 2 to splice S3; second transition optical fiber T2 to a splice S4; and optical fiber 3a of fiber optic cable 3 to splice S4. Splices of the present invention can include, for example, a plastic shrink wrap therearound for protection of the same from stress and/or strain. For purposes of clarity only one optical pathway is shown in cassette 40; however, cassette 40 can contain a plurality of optical pathways, for example, 24 separate optical pathways.

As assembled, cassette 40 houses a portion of at least one bridge fiber 42 therein. More specifically, as depicted in FIG. 13a, at least a portion of bridge fiber 42 is disposed within first storage area 43a of first tray 43. First storage area 43a is sized so that when bridge fiber 42 is coiled and stored therein it does fall below a minimum bend radius. In one embodiment, ends 42a,42b of bridge fiber 42 are capable of being optically connected with respective first ends E1,E2 of a pair of transition optical fibers T1,T2 (FIG. 13a ) having predetermined, dispersion characteristics, which can be different. For example, first transition optical fiber T1 can be a D+ optical fiber, having optical characteristics similar to optical fiber 2a. On the other hand, second transition optical fiber T2 can be a D-optical fiber, having optical characteristics similar to optical fiber 3a. The optical connections between ends 42a,42b of bridge fiber 42 and respective first ends E1,E2 of transition optical fibers T1,T2, for example, splices S1,S2 (FIG. 13a ) are stored in first storage area 43a of first tray 43. In other words, splices S1,S2 are housed in first storage area 43a so that they cannot be accidentally or easily accessed by the craftsman, i.e., the bolts would have to be removed to access the same. Additionally, cassette 40 can be marked by suitable means notifying the craftsman not to access and/or tamper with splices S1,S2.

Preferably, bridge fiber 42 has a predetermined length so that it can be stored in first storage area 43a with a predetermined number of coils therein. For example, bridge fiber 42 has a length of about 1-5 meters; however, any other suitable length can be used. Using a predetermined length within first storage area 43a allows splices S1,S2 to be located at a predetermined position within first storage area 43a. Preferably, splices S1,S2 lie along the longest length of first storage area 43a, thereby maximizing the bend radius along splices S1,S2. In other words, splices S1,S2 preferably are not appreciably bent, thereby inhibiting stresses and/or strains on splices S1,S2.

Advantageously, in one embodiment splices S1,S2 are performed in a factory environment with precision alignment splicing equipment so that splice losses between transition optical fibers T1,T2 and bridge fiber 42 are minimized. Transition optical fibers T1,T2, are preferably selected to have the same, or similar, optical characteristics as optical fibers of the optical fiber cables that are intended to enter closure 10. However, any other suitable transition fibers can be used. Performing splices S1,S2 in the factory allows the craftsman to splice together the same, or similar, optical fibers in the field, rather performing splices between bridge fiber 42 and transition optical fibers T1,T2, which may require special equipment, procedures, and/or training. Additionally, performing splices S1,S2 in the factory is more efficient, facilitates testing of the splices, and does not require special and expensive equipment to be carried in the field by the craftsman.

Conversely, a pair of other ends O1,O2 (FIGS. 13b and 13d) of transition optical fibers T1,T2 are intended for optical connection in the field by the craftsmen. Specifically, other ends O1,O2 are capable of being optically connected with optical fibers 2a,3a of respective fiber optic cables 2,3 having predetermined dispersion characteristics that are, respectively, similar to transition optical fibers T1,T2. In one embodiment, other ends O1,O2 are disposed in second storage area 44a. The optical connection between O1,O2 and optical fibers 2a,3a can be, for example, splices S3,S4, however, other suitable optical connections can be used. Since, optical fibers 2a,3a preferably have the same, or similar, characteristics compared with transition optical fibers T1,T2, the splicing operation therebetween is relatively easy and can be performed in the field. Thus, splices having suitable optical performance can efficiently be made in the field by the craftsman, thereby forming an optical pathway capable of transmitting optical signals with a relatively low splice-loss between optical fibers 2a,3a of respective fiber optic cables.

As illustrated in the embodiment of FIG. 9, a portion of transition optical fibers T1, T2 are disposed in respective transition sections 47,48. Transitions sections 47,48 protect transition optical fibers T1, T2 from undue stress and/or strain during, for example, routing the transition optical fibers T1,T2 from first tray 43 to second tray 44 of cassette 40. Generally speaking, transition sections 47,48 inhibit pinching or snagging of transition optical fibers T1,T2 during routing between the trays, which can damage the same and/or degrade optical performance. Transition sections 47,48 can be, for example, transition tubes as depicted in FIGS. 11 and 12, which shows the orientation of the transition tubes between first tray 43 and second tray 44. Transition sections 47,48 can be securely held in place by respective tabs 41a,41b of first and second trays 43,44. However, other suitable orientations of transition sections and/or securement of the same can be used such as clamps or tie wraps. In still other embodiments, transition sections 47,48 may not be required or can have other configurations such as a plastic spiral tube or a tape. However, the optical fibers should not have a bend radius below a suitable minimum bend radius in order to preserve optical performance.

Additionally, transition sections 47,48 can include a marking indicia 47a,48a to aid the craftsman in identifying the different transition optical fibers T1,T2. For example, the tubes can be different colors such as a blue tube for a D+ transition optical fiber and a green tube for a D− optical fiber. For purposes of illustration, the marking indicia 47a,48a are respectively represented in the drawings with a shaded tube and a non-shaded tube. However, other suitable marking indicia 47a, 48a can be used, for example, stripes, decals, embossing, or the like. Moreover, marking indicia 47a,48a can be located on other suitable components of cassette 40 such as a stamping on second storage area 44a adjacent to where the transition fibers T1,T2 enter. Additionally, the concepts of the present invention can be practiced with cassettes having other suitable configurations and/or other numbers of trays. FIG. 14 illustrates a portion of another explanatory cassette assembly 140 according to the present inventions that is similar to cassette 40. Cassette 140 includes first and second trays 143,144 having respective first and second storage areas 143a,144a, at least one fastening element 145, a first plate 146a, a pair of transition tubes similar to those shown in FIG. 9, a plurality of splice organizers 149, and a second plate 146b. Cassette 140 is essentially the same as cassette 40, except first plate 146 covers first storage area 143a. Otherwise, the features and operations are essentially the similar to cassette 40.

Additionally, the concepts of the present invention can also be practiced without transition optical fibers T1,T2. In other words, bridge optical fiber 42 would be optically connected directly to optical fibers 2a,3a within closure 10. Other modifications of the present invention can include more than one optical fiber interposed between the bridge optical fiber and optical fibers of the cables. In one embodiment, a cassette having a single storage area can house bridge fiber 42 and the optical connections. In other embodiments, bridge fiber 42 can be used with cassettes 40,140 and bridge fiber 42 can be routed to the second storage area for direct optical connection with optical fibers 2a,3a. Additionally, other suitable configurations can be practiced with the concepts of the present invention.

FIG. 15 illustrates an another cassette assembly 240 (hereinafter cassette) for housing bridge fiber 42 according to the present invention. Cassette 240 includes tray 243 and plate 246. Tray 243 includes a raceway 241 for routing optical fibers therein, a pair of fastening elements 245, and a standoff 250 having a bore therethrough. Plate 246 includes a pair of rectangular apertures 245a for receiving fastening elements 245 and an aperture 252. FIG. 16 illustrates cassette 240 after assembly. Plate 246 is secured to tray 243 by fastening elements 245 and the bore of standoff 250 and aperture 252 are aligned, thereby allowing a securing element 255 to pass therethrough.

FIG. 15a depicts bridge fiber 42 and splices S1,S2 disposed in cassette 240. In this embodiment, the optical connection, for example, splices S3,S4 between optical fibers 2a,3a and transition optical fibers T1,T2 occurs in a second cassette 280 as shown in FIG. 21. Closures using cassette 240 route ends O1,O2 of transition optical fibers T1,T2, or ends of a bridge optical fiber, to a second cassette 280 disposed within a closure. For example, as depicted in FIG. 21, a plurality of cassettes 240 are located on one side of a frame assembly 216 and a plurality of second cassettes are located on the other side of frame assembly 216. A pair of transition sections 247,248, for example, tubes route a portion of transition optical fibers T1,T2 from cassette 240 to second cassette 280. Second cassette 280 includes a tray 280a and plate 280b. However, second cassette can include other suitable components such as splice organizers. Cassettes 240 and second cassettes 280 can be secured to frame assembly 216 using suitable means. For example, cassettes 240 can be secured to frame assembly by bolts 255 and second cassettes 280 can be secured with Velcro® straps.

Ends of transition sections 247,248 can be attached to respective portions of cassette 240 and second cassette 280 as described herein. For example, transition section 247 can be attached to apertures of tray 243 using tie straps. In other embodiments, bridge fibers 42 from several cassettes 240 can be routed a single second cassette 280. Cassette 240 and second cassette 280 can be, for example, different shapes, colors and/or marked to indicate to the craftsman that the optical connection between optical fiber 2a,3a and transition optical fibers T1,T2 is intended to occur in field cassette 250. Additionally, cassettes 240 can be marked and/or made tamper-resistant to prevent the craftsman from accessing the same.

FIG. 17 illustrates an another cassette assembly 340 (hereinafter cassette), similar to cassette 240, for housing bridge fiber 42 according to the present inventions. Cassette 340 includes a tray 343 a first plate 346a, and a second plate 346b. Cassette 340 incorporates features similar to cassette 240 and essentially operates in the same manner. FIG. 15a depicts bridge fiber 42 disposed in cassette 240. In this embodiment, bridge fiber 42 is routed to through transition sections to a second cassette for direct optical connection with optical fibers of a pair of optical fibers; however, transition optical fibers could also be used. FIG. 18 illustrates cassette 340 after assembly.

FIGS. 19 and 20 depict an exemplary in-line closure 200 with its housing removed. Closure 200 is similar to closure 10, except instead of the housing being closed on one end it has an additional end cap. More specifically, a pair of end caps 212 are respectively positioned at opposite ends of closure 200 and are intended to close respective openings on opposite ends of the housing (not shown). This type of closure allows fiber optic cables to enter and/or exit the in-line splice closure from either or both ends. Otherwise, closure 200 operates in a manner similar to closure 10. For example, each end of frame assembly 216 is attached to a respective end cap 212 and at least one fiber optic cassette assembly 40 can be removable secured in one of a plurality of cassette stackers 219. As discussed with respect to closure 10, each end cap 212 can be secured to a respective flange on the housing using O-rings and collar, or with other suitable elements.

Many modifications and other embodiments of the present invention, within the scope of the appended claims, will become apparent to a skilled artisan. For example, the bridge fiber can be disposed in other configurations within the cavity of the closure while still employing the concepts of the present invention, rather than at least partially disposed within a cassette. Additionally, fiber optic cable closures of the present invention can include other suitable components and/or configurations. Therefore, it is to be understood that the invention is not to be limited to the specific embodiments disclosed and that modifications and other embodiments may be made within the scope of the appended claims. Although specific terms are employed herein, they are used in a generic and descriptive sense only and not for purposes of limitation. The invention has been described with reference to splices between optical fibers, but the inventive concepts of the present invention are applicable to other suitable optical connections as well.

That which is claimed:

1. A fiber optic cable closure for containing optical fibers of a dispersion-managed network, the fiber optic closure comprising:
a housing having a cavity; and
at least one bridge optical fiber disposed within the cavity, the bridge optical fiber having a first end and a second end, the first end being configured to optically connect to a first optical fiber having a first dispersion characteristic, and the second end being configured to optically connect to a second optical fiber having a second dispersion characteristic.

2. The fiber optic cable closure according to claim 1, further comprising an optical connection between the at least one bridge optical fiber and a first end of a first optical fiber, the first optical fiber being a transition optical fiber being selected from the group of a positive dispersion (D+) optical fiber and a negative dispersion (D−) optical fiber.

3. The fiber optic cable closure according to claim 1, further comprising:
a first optical fiber, the first optical fiber having an optical connection, the optical connection capable of transmitting optical signals between the at least one bridge optical fiber and the first optical fiber; and
a fiber optic cassette, wherein the optical connection is disposed in the fiber optic cassette.

4. The fiber optic cable closure according to claim 2, further comprising:
a first fiber optic cassette, the first fiber optic cassette having a portion of the bridge optical fiber and the optical connection disposed therein; and
a second fiber optic cassette, the second fiber optic cassette having an other end of the first optical fiber disposed therein.

5. The fiber optic cable closure according to claim 1, further comprising a first optical fiber, the first optical fiber being in optical communication with the at least one bridge optical fiber, wherein the first optical fiber is a transition optical fiber having a positive dispersion (D+) characteristic, and the at least one bridge optical fiber and first optical fiber each have a predetermined mode field diameter, and wherein the mode field diameter of the first optical fiber is greater than the mode field diameter of the at least one bridge optical fiber.

6. The fiber optic cable closure according to claim 1, further comprising a second optical fiber, the second optical fiber in optical communication with the at least one bridge optical fiber, wherein the second optical fiber is a transition optical fiber having a negative dispersion (D−) characteristic, and the at least one bridge optical fiber and second optical fiber each have a predetermined mode field diameter, and wherein the mode field diameter of the first optical fiber is less than than the mode field diameter of the at least one bridge optical fiber.

7. The fiber optic cable closure according to claim 1, further comprising a fiber optic cassette, the fiber optic cassette containing at least a portion of the bridge optical fiber.

8. The fiber optic cable closure according to claim 1, further comprising:
a fiber optic cassette, the fiber optic cassette comprising a first tray and a second tray, the first tray containing at least a portion of the bridge optical fiber;
a first optical fiber, the first optical fiber being a transition optical fiber in optical communication with the at least one bridge optical fiber; and
a transition section, wherein the transition section protects and routes and a portion of the first optical fiber to the second tray.

9. The fiber optic cable closure according to claim 8, the transition section having a marking indicia.

10. The fiber optic cable closure according to claim 1, further comprising an indicia on the fiber optic cable closure, the indicia denoting a dispersion characteristic of a fiber optic cable entering the fiber optic cable closure.

11. The fiber optic cable closure according to claim 1, further comprising:
a first optical fiber, the first optical fiber being a first transition optical fiber having a first end, and the first optical fiber having a positive dispersion (D+) characteristic and a predetermined mode field diameter;
a second optical fiber, the second optical fiber being a second transition optical fiber having a first end, and the first optical fiber having a negative dispersion (D−) characteristic and a predetermined mode field diameter;
a fiber optic cassette, the fiber optic cassette having a first storage area, a portion of the at least one bridge optical fiber being disposed within the first storage area;
a first optical connection, the first optical connection being between the first end of the at least one bridge optical fiber and a first end of the first optical fiber, the first optical connection disposed within the first storage area;
a second optical connection, the second optical connection being between the second end of the at least one bridge optical fiber and a first end of a second optical fiber, the second optical connection disposed within the first storage area; and
the at least one bridge optical fiber has a predetermined mode field diameter, wherein the mode field diameter of the first optical fiber is greater than the mode field diameter of the at least one bridge optical fiber, and the mode field diameter of the second optical fiber is less than the mode field diameter of the at least one bridge optical fiber.

12. The fiber optic cable closure according to claim 11, the first optical fiber having an other end, the second optical fiber having an other end, and the fiber optic cassette further comprising a second storage area, wherein the respective other ends of the first and second optical fibers are disposed in the second storage area of the fiber optic cassette.

13. A fiber optic cassette for containing optical fibers of a dispersion-managed network, the fiber optic cassette comprising:
a first storage area; and
at least one bridge optical fiber having a first and second end, at least a portion of the bridge optical fiber is disposed within the first storage area, wherein the first end is configured to optically connect with a first optical fiber having a first dispersion characteristic, and the second end is configured to optically connect with a second optical fiber having a second dispersion characteristic.

14. The fiber optic cassette according to claim 13, further comprising an optical connection between the at least one bridge optical fiber and a first optical fiber, the first optical fiber being a transition optical fiber, and the first optical fiber being selected from the group of a positive dispersion (D+) optical fiber and a negative dispersion (D−) optical fiber.

15. The fiber optic cassette according to claim 14, the optical connection being disposed within the first storage area of the fiber optic cassette.

16. The fiber optic cassette according to claim 14, the first optical fiber having an other end, the other end being disposed within a second storage area of the fiber optic cassette.

17. The fiber optic cassette according to claim 14, the first optical fiber having an other end, the other end being disposed within a second fiber optic cassette.

18. The fiber optic cassette according to claim 13, further comprising:
a first optical fiber, the first optical fiber being a transition optical fiber having a first end and an other end, the transition optical fiber being selected from the group of a positive dispersion (D+) optical fiber and a negative dispersion (D−) optical fiber; and
an optical connection, the optical connection being between the at least one bridge optical fiber and the first end of the first optical fiber, the optical connection being disposed within the first storage area;
a second storage area of the fiber optic cassette, the other end of the first optical fiber being disposed within the second storage area of the fiber optic cassette; and
a plate, the plate covering a portion of a second storage area of the fiber optic cassette.

19. The fiber optic cassette according to claim 13, further comprising a first optical fiber, the first optical fiber being in optical communication with the at least one bridge optical fiber, wherein the first optical fiber is a transition optical fiber having a positive dispersion (D+) characteristic, and the at least one bridge optical fiber and first optical fiber each have a predetermined mode field diameter, and wherein the mode field diameter of the first optical fiber is greater than the mode field diameter of the at least one bridge optical fiber.

20. The fiber optic cassette according to claim 13, further comprising a second optical fiber, the second optical fiber being in optical communication with the at least one bridge optical fiber, wherein the second optical fiber is a transition optical fiber having a negative dispersion (D−) characteristic, and the at least one bridge optical fiber and second optical fiber each have a predetermined mode field diameter, and wherein the mode field diameter of the first optical fiber is less than than the mode field diameter of the at least one bridge optical fiber.

21. The fiber optic cassette according to claim 13, further comprising:
a second storage area of the fiber optic cassette;
a first optical fiber, the first optical fiber being a transition optical fiber, the first optical fiber being in optical communication with the bridge optical fiber; and
a transition section, the transition section protects and routes and a portion of the first optical fiber to the second storage area.

22. The fiber optic cassette according to claim 22, the transition section having a marking indicia.

23. The fiber optic cassette according to claim 22, the transition section being a tube.

24. The fiber optic cassette according to claim 13, the fiber optic cassette being disposed in a fiber optic cable closure.

25. A fiber optic cassette for containing optical fibers of a dispersion-managed network, the fiber optic cassette comprising:
a first storage area;
a second storage area;
at least one bridge optical fiber having a first end and a second end, at least a portion of the at least one bridge optical fiber being disposed in the first storage area;
a first optical fiber, the first optical fiber being a transition optical fiber having a positive dispersion (D+) characteristic, the first transition optical fiber being in optical communication with the first end of the at least one bridge optical fiber;
a second optical fiber, the second optical fiber being a transition optical fiber having a negative dispersion (D−) characteristic, the second transition optical fiber being in optical communication with the second end of the at least one bridge optical fiber; and
at least a portion of the first and second optical fibers being disposed in the second storage area.

26. The fiber optic cassette according to claim 25, further comprising a plate, the plate covering a portion of the second storage area of the fiber optic cassette.

27. The fiber optic cassette according to claim 25, the fiber optic cassette being disposed within a fiber optic cable closure.

28. The fiber optic cassette according to claim 25, further comprising at least one transition section, the transition section protecting and routing and a portion of one of the optical fibers to the second storage area.

29. The fiber optic cable closure according to claim 28, the transition section having a marking indicia.

30. The fiber optic cassette according to claim 28, the transition section being a tube.

31. A dispersion-managed network comprising:
a first fiber optic cable having at least one positive dispersion (D+) optical fiber;
a second fiber optic cable having at least one negative dispersion (D−) optical fiber;
a fiber optic cable closure having a housing with a cavity, at least a portion of the first and second fiber optic cables disposed within the cavity; and
at least one bridge optical fiber having a first and second end disposed within the cavity of the housing, the at least one D+ and D− optical fibers being in optical communication with the at least one bridge optical fiber.
